(19) United States
(12) Patent Application Publication
(10) Pub. No.: US 2026/0296258 A1
(43) Pub. Date: Oct. 1, 2026

(54) CHARGING MANAGEMENT SYSTEM, CHARGING MANAGEMENT DEVICE, AND CHARGING MANAGEMENT METHOD

(71) Applicant: HONDA MOTOR CO., LTD., Tokyo (JP)

(72) Inventors: Masanori Sasaki, Tokyo (JP); Masaki Ueno, Tokyo (JP)

(21) Appl. No.: 19/534,824

(22) Filed: Feb. 10, 2026

(30) Foreign Application Priority Data
Mar. 28, 2025 (JP) 2025-055007

(51) Int. Cl. B60L 53/67; B60L 53/62; H02J 3/38

(52) U.S. Cl. CPC B60L 53/67; B60L 53/62; H02J 3/38

(57) ABSTRACT

A charging management system includes: a charging station to which renewable energy and grid energy are supplied; a plurality of electric vehicles having an in-vehicle power storage device that charges the renewable energy and the grid energy supplied from the charging station; and a vehicle management part that manages an amount of the renewable energy stored in the in-vehicle power storage device of each of the plurality of electric vehicles. The vehicle management part includes a power consumption acquisition part that acquires an estimated value of power consumption per predetermined period of each of the plurality of electric vehicles, and in a case where charging of each of the plurality of electric vehicles is performed using energy from the charging station, the vehicle management part preferentially charges the renewable energy to an electric vehicle having the greater estimated value.

### CROSS-REFERENCE TO RELATED APPLICATION

Priority is claimed on Japanese Patent Application No. 2025-055007, filed Mar. 28, 2025, the content of which is incorporated herein by reference.

### BACKGROUND OF THE INVENTION

### Field of the Invention

The present invention relates to a charging management system, a charging management device, and a charging management method.

### Description of Related Art

In recent years, in order to ensure that more people have access to affordable, reliable, sustainable, and advanced energy, research and development on renewable energy that contributes to energy efficiency has been conducted. On the other hand, in technologies related to renewable energy, technologies related to a management system that manages charging and driving of electric vehicles using renewable energy and grid energy have been disclosed (refer to, for example, Japanese Patent No. 6224205). This management system clearly manages sources of energy and promotes use of renewable energy by providing incentives in a case where renewable energy is selected for driving.

In the technology described in Japanese Patent No. 6224205, a charging device and an electric vehicle are connected to a server through respective communication lines and exchange a renewable energy rate and remaining battery power. The technology described in Japanese Patent No. 6224205 can calculate the amount of CO₂ emissions when using the electric vehicle by distinguishing a type of energy consumed by the electric vehicle (renewable energy and grid energy). The amount of CO₂ emissions is calculated, for example, by an equation of coefficient×power consumption. The coefficient is annually updated, for example, by an electricity supplier.

### SUMMARY OF THE INVENTION

In the management system disclosed in Japanese Patent No. 6224205, the amount of CO₂ emissions can be reduced by allowing the electric vehicle to select renewable energy and perform driving using the renewable energy. However, the management system aims to increase consumption of renewable energy for each electric vehicle. For this reason, it was difficult to satisfy the needs of, for example, an organization or a company with a plurality of electric vehicles to minimize the entire amount of CO₂ emissions when using electric vehicles.

An aspect of the present invention provides a charging management system, a charging management device, and a charging management method capable of reducing the total amount of CO₂ emissions when using a plurality of electric vehicles. The aspect of the present invention contributes to energy efficiency.
(1) According to an aspect of the present invention, there is provided a charging management system including: a charging station to which renewable energy generated by a power generation device and grid energy from a grid energy source are supplied; a plurality of electric vehicles having an in-vehicle power storage device that charges the renewable energy and the grid energy supplied from the charging station when being electrically connected to the charging station; and a vehicle management part that manages an amount of the renewable energy stored in the in-vehicle power storage device of each of the plurality of electric vehicles, in which the vehicle management part includes a power consumption acquisition part that acquires an estimated value of power consumption per predetermined period of each of the plurality of electric vehicles, and in a case where charging of each of the plurality of electric vehicles is performed using energy from the charging station, the vehicle management part preferentially charges the renewable energy to an electric vehicle having the greater estimated value.
(2) In the charging management system according to the aspect (1), the predetermined period may be a period related to a charging cycle for charging the plurality of electric vehicles.
(3) In the charging management system according to the aspect (1), the estimated value may be an average value.
(4) In the charging management system according to the aspect (1), the estimated value may relate to at least one of a traveling distance of the electric vehicle or an air conditioning control level of an air conditioning device provided in the electric vehicle.
(5) According to another aspect of the present invention, there is provided a charging management device including: a vehicle management part that manages an amount of renewable energy stored in an in-vehicle power storage device of each of a plurality of electric vehicles, which have the in-vehicle power storage device that charges the renewable energy and grid energy supplied from a charging station when the in-vehicle power storage device is electrically connected to the charging station, the renewable energy being generated by a power generation device and the grid energy being supplied from a grid energy source, in which the vehicle management part includes a power consumption acquisition part that acquires an estimated value of power consumption per predetermined period of each of the plurality of electric vehicles, and in a case where charging of each of the plurality of electric vehicles is performed using energy from the charging station, the vehicle management part preferentially charges the renewable energy to an electric vehicle having the greater estimated value.
(6) According to still another aspect of the present invention, there is provided a charging management method causing a computer to execute a process including: managing an amount of renewable energy stored in an in-vehicle power storage device of each of a plurality of electric vehicles, which have the in-vehicle power storage device that charges the renewable energy and grid energy supplied from a charging station when the in-vehicle power storage device is electrically connected to the charging station, the renewable energy being generated by a power generation device and the grid energy being supplied from a grid energy source, in which the method causes the computer to acquire an estimated value of power consumption per predetermined period of each of the plurality of electric vehicles, and in a case where charging of each of the plurality of electric vehicles is performed using energy from the charging station, the method causes the computer to preferentially charge the renewable energy to an electric vehicle having the greater estimated value.

According to the aspects (1) to (6), it is possible to reduce the total amount of CO₂ emissions when using a plurality of electric vehicles.

### BRIEF DESCRIPTION OF THE DRAWINGS

FIG. 1 is a diagram illustrating an example of a configuration of a charging management system according to an embodiment.

FIG. 2 is a diagram illustrating an example of content of power consumption.

FIG. 3 is a flowchart illustrating an example of processing by a charging management device.

FIG. 4 is a diagram illustrating a comparison result of the amounts of CO₂ emissions between an example and a comparative example.

### DETAILED DESCRIPTION OF THE INVENTION

Hereinafter, embodiments of a charging management system, a charging management device, and a charging management method according to the present invention will be described with reference to the accompanying drawings. In the drawings used in the following description, the scale of each component has been changed as necessary such that each component can be clearly recognized. In all drawings used to describe the embodiment, the same reference symbol is used for components having the same function, and a repeated description is omitted.

In this specification, “based on XX” means “based on at least XX” and includes cases where it is based on another element in addition to XX. That is, “based on XX” is not limited to cases where XX is directly used, but also includes cases where it is based on results obtained by performing calculation or processing on XX. “XX” is any element (for example, any information).

In the present embodiment, in a case where a plurality of electric vehicles are owned by electric vehicle owners (for example, schools, public and private sector organizations, companies, and the like), an estimated value of power consumption is acquired based on a usage history of each electric vehicle (for example, a driving history, an air conditioning control history) or an input operation of the electric vehicle owner, or the like, and renewable energy is preferentially distributed to electric vehicles with large (high) estimated values. Thereby, as compared with a case where renewable energy is equally distributed to each electric vehicle, the amount of CO₂ emissions of the owners as a whole can be reduced, for example, can be minimized.

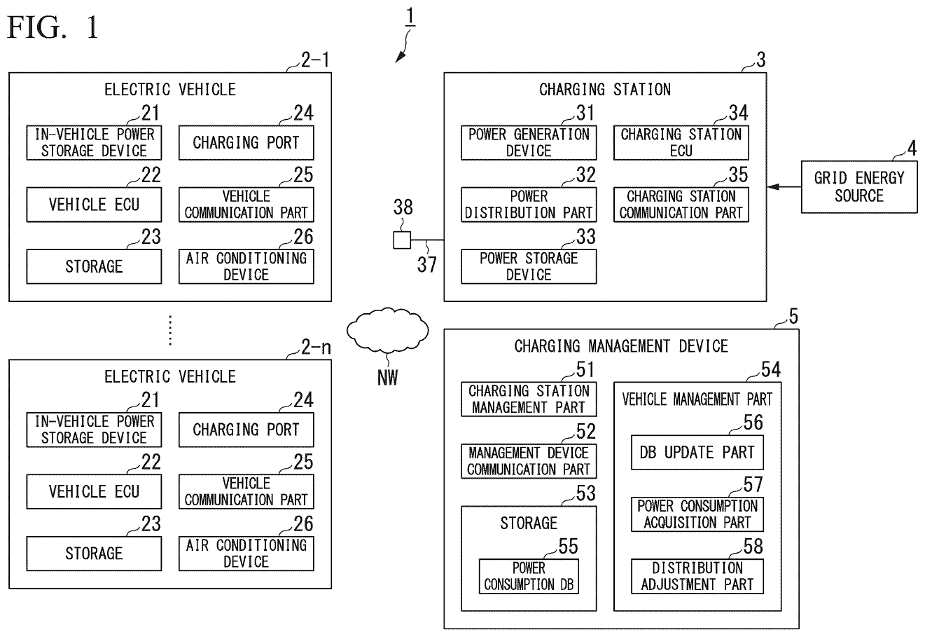

FIG. 1 is a diagram illustrating an example of a configuration of a charging management system 1 according to the present embodiment. The charging management system 1 includes, for example, a plurality of electric vehicles 2(2-1, . . . , 2-n) (n is an integer of two or more), a charging station 3, a grid energy source 4, and a charging management device 5. The charging management device 5 may be located, for example, outside the electric vehicle 2, in a management center that performs charging management, in a cloud server, in the charging station 3, or in the electric vehicle 2.

The electric vehicle 2 and the charging station 3 are connected to each other via a wired or wireless network NW when charging. The electric vehicle 2 and the charging management device 5 are connected to each other via a wireless network NW. In a case where the charging management device 5 is provided in the electric vehicle 2, a device in the electric vehicle 2 may be connected to the charging management device 5 via a wired network NW. The charging station 3 and the charging management device 5 are connected to each other via a wired or wireless network NW.

In a case where stored power becomes insufficient, the electric vehicle 2 travels to, for example, the charging station 3 and receives supply of power from the charging station 3. Thus, charging of the electric vehicle 2 is performed. The power used for charging is renewable energy (RE) or grid energy (GE). Whether the energy used for charging of the electric vehicle 2 is renewable energy or grid energy is managed by the charging management device 5. The charging management device 5 instructs the charging station 3 to distribute the power for charging of the electric vehicle 2, and the charging station 3 performs charging of the electric vehicle 2 by using the renewable energy and the grid energy which are distributed based on the instruction of the charging management device 5.

The electric vehicle 2 is an electric vehicle (EV) that travels by using electricity as an energy source and using power from an electric motor (not illustrated). The electric vehicle 2 includes, for example, an in-vehicle power storage device 21, a vehicle ECU 22, a storage 23, a charging port 24, a vehicle communication part 25, and an air conditioning device 26. The electric vehicle 2 is, for example, an electric automobile, but the electric vehicle 2 may also be a hybrid vehicle, a fuel cell vehicle, an electric motorcycle, or the like.

The in-vehicle power storage device 21 is a storage battery, a capacitor, or the like that is mounted in the electric vehicle 2. The in-vehicle power storage device 21 is charged by power supplied from the charging station 3 via the charging port 24 according to control of the vehicle ECU 22. The in-vehicle power storage device 21 stores at least one of the renewable energy or the grid energy supplied from the charging station 3 in a case where the electric vehicle 2 and the charging station 3 are electrically connected to each other.

The power stored in the in-vehicle power storage device 21 is supplied to each unit of an electric system of the electric vehicle 2 (for example, the electric motor). Identification information that is identifiable may be assigned to the in-vehicle power storage device 21. The in-vehicle power storage device 21 may include a plurality of cells, and identification information that is identifiable may be assigned to each cell.

The vehicle ECU 22 is an electronic control unit. The vehicle ECU 22 controls storage of power in the in-vehicle power storage device 21 and supply of the stored power to each unit of the electric system of the electric vehicle 2. The vehicle ECU 22, the in-vehicle power storage device 21, the electric motor, the vehicle communication part 25, and the like are connected to each other, for example, via communication lines such as a controller area network (CAN).

The vehicle ECU 22 calculates a distance traveled by the vehicle (hereinafter, referred to as “traveling distance”), for example, for every day based on detection results of various sensors such as wheel speed sensors. The vehicle ECU 22 manages and monitors the remaining amount (state of charge, SOC) of the power (energy) stored in the in-vehicle power storage device 21. The vehicle ECU 22 stores the acquired traveling distance and the remaining energy amount SOC in the storage 23.

The vehicle ECU 22 transmits the acquired traveling distance and the acquired remaining energy amount SOC to the charging management device 5 via the vehicle communication part 25. The vehicle ECU 22 may calculate power consumption of the electric vehicle 2 based on the calculated traveling distance. In this case, the vehicle ECU 22 may store the calculated power consumption in the storage 23, or may transmit the calculated power consumption to the charging management device 5 via the vehicle communication part 25.

The vehicle ECU 22 may store power generated by regenerative energy of the electric motor in the in-vehicle power storage device 21. In a case where the in-vehicle power storage device 21 includes a plurality of cells, the vehicle ECU 22 may store, in the storage 23, information about which cell stores power of renewable energy in association with the identification information of the cell. The regenerative energy may be treated separately from the renewable energy and the grid energy.

The vehicle ECU 22 may calculate power of a load other than the electric motor, such as the air conditioning device 26, and may store the calculated power in the storage 23 or may transmit the calculated power to the charging management device 5 via the vehicle communication part 25. In a case where the load is the air conditioning device 26, the vehicle ECU 22 may calculate power consumption of the air conditioning device 26 (hereinafter, referred to as air conditioning power consumption) based on a use time, a setting temperature, and the like of the air conditioning device 26, and may store the air conditioning power consumption in the storage 23.

The storage 23 is, for example, a semiconductor memory element such as a flash memory, a hard disk, an optical disc, or the like. The storage 23 acquires information acquired by the vehicle ECU 22, such as the energy amount, the calculated traveling distance, and the remaining energy amount SOC of the in-vehicle power storage device 21. The traveling distance and the remaining energy amount SOC that are stored in the storage 23 are transmitted to the charging station 3 and the charging management device 5 via the vehicle communication part 25, as necessary. The information such as the traveling distance and the remaining energy amount SOC may be transmitted to the charging station 3 or the charging management device 5 without being stored in the storage 23.

The charging port 24 can be connected to a charging plug 38 (to be described) provided at the charging station 3. In a case where the charging plug 38 is connected to the charging port 24, the electric vehicle 2 and the charging station 3 are electrically connected to each other via a cable 37 (to be described). In a case where the electric vehicle 2 and the charging station 3 are electrically connected to each other, charging of the electric vehicle 2 is performed by using the power from the charging station 3.

The vehicle communication part 25 includes, for example, a communication interface such as a network interface card (NIC). The vehicle communication part 25 transmits and receives information to and from the charging station 3 and the charging management device 5. The vehicle communication part 25 transmits, for example, the traveling distance and the remaining energy amount SOC of the in-vehicle power storage device 21 that are acquired by the vehicle ECU 22 or are stored in the storage 23 to the charging management device 5 via the network NW.

The air conditioning device 26 is, for example, a heating/cooling device, a blower, or the like that is mounted on the electric vehicle 2. The air conditioning device 26 is controlled, for example, by the vehicle ECU 22. In a case where the vehicle ECU 22 calculates the air conditioning power consumption, the vehicle ECU 22 may transmit the air conditioning power consumption to the charging management device 5 via the vehicle communication part 25. Instead of the air conditioning power consumption, the vehicle ECU 22 may transmit a control level of the air conditioning device 26 to the charging management device 5, and the charging management device 5 may calculate the air conditioning power consumption.

The charging station 3 manages the amount of renewable energy (hereinafter, referred to as renewable energy amount). The charging station 3 supplies the power obtained from the renewable or the grid energy to the electric vehicle 2. The grid energy is supplied from, for example, a grid energy source 4 such as an electric power company via a cable. The charging station 3 may include an operation unit, a display unit, and the like. A plurality of charging stations 3 may be provided, for example, at each business base of a business operator that operates the charging stations 3.

The charging station 3 includes, for example, a power generation device 31, a power distribution part 32, a power storage device 33, a charging station ECU 34, and a charging station communication part 35. The power generation device 31 is a power generation device that generates power which is renewable energy. The power generation device 31 is an energy generation device with low amount of CO₂ emissions during power generation, such as a solar cell panel, a wind power generation device, a geothermal power generation device, or the like. The power generation device 31 transmits the generated power to the power distribution part 32 or the power storage device 33. The charging station 3 may not include the power generation device 31 and the power storage device 33. The charging station 3 may directly supply the grid energy supplied by the grid energy source 4 to the electric vehicle 2.

The cable 37 is connected to the power distribution part 32, and the charging plug 38 is connected to the cable 37. A plurality of cables 37 and a plurality of charging plugs 38 may be provided. The power distribution part 32 supplies power of the renewable energy stored in the power storage device 33 or power of the grid energy supplied by the grid energy source 4 to the electric vehicle 2 via the cable 37 and the charging plug 38 according to a control of the charging station ECU 34. The power from the grid energy source 4 or the power generation device 31 may be directly supplied to the electric vehicle 2 without passing through the power distribution part 32.

The power storage device 33 stores the power. The power storage device 33 is, for example, a storage battery or a capacitor. The power storage device 33 stores the power generated by the power generation device 31 and the power supplied by the grid energy source 4. The power storage device 33 supplies the stored power to the power distribution part 32 according to a control of the charging station ECU 34.

The charging station ECU 34 stores the power of the renewable energy generated by the power generation device 31 in the power storage device 33. The charging station ECU 34 manages the amount of renewable energy stored in the power storage device 33, and recognizes the amount of renewable energy that can be used for charging of the electric vehicle 2. The charging station ECU 34 provides the amount of renewable energy that can be used for charging to the charging management device 5.

The charging management device 5 generates a distribution instruction by using the transmitted renewable energy amount and other information, and transmits the distribution instruction to the charging station ECU 34. The distribution instruction includes, for each electric vehicle 2, information indicating the amount of renewable energy to be used for charging. The distribution instruction may include information indicating the amount of the grid energy (hereinafter, referred to as grid energy amount). In the distribution instruction, the amount of renewable energy may be zero.

The charging station ECU 34 distributes the power of renewable energy stored in the power storage device 33 according to the distribution instruction transmitted by the charging management device 5, and controls supply of the power of renewable energy. The charging station ECU 34 controls supply of the power of grid energy as needed according to the distribution instruction transmitted by the charging management device 5.

The charging station communication part 35 includes a communication interface such as an NIC card. Transmission and reception of information is performed between the charging station 3 and the charging management devices 5. The charging station communication part 35 receives, for example, the distribution instruction transmitted by the charging management device 5, and transmits the distribution instruction to the charging station ECU 34. The cable 37 has one end which is connected to the power distribution part 32 and the other end which is connected to the charging plug 38. The charging plug 38 is, for example, a charging plug conforming to the “J1772” standard or the “CHAdeMO” standard. The charging plug 38 may be a charging plug conforming to another charging standard.

The charging management device 5 is, for example, a server provided in a traveling management center or the like. The charging management device 5 acquires an estimated value of power consumption per predetermined period, for a plurality of electric vehicles 2 that travel using electric energy, based on a traveling distance and a power consumption history of each vehicle. The predetermined period is defined, for example, based on a period related to a charging cycle in which the electric vehicle owner charges the electric vehicle 2. For example, in a case where the electric vehicle owner charges the electric vehicle 2 daily, the charging cycle is one day. The predetermined period may be in units of days, in units of weeks such as one week, or in units of hours such as 12 hours.

The estimated value of power consumption may be an estimated value of the power consumption itself, or information for calculating the power consumption, for example, an estimated value of the traveling distance of the electric vehicle 2, or an estimated value of the air conditioning control level of the air conditioning device. Alternatively, the estimated value of power consumption may be a numerical value based on an operation of an input device such as a keyboard or a touch panel provided in the charging management device 5, the input device being operated by a staff member of the electric vehicle owner or the like. The estimated value of power consumption may also be an estimated value of a calculated value that is calculated by an arithmetic expression based on the traveling distance of the electric vehicle 2 or the air conditioning control level of the air conditioning device.

The estimated value of power consumption is, for example, a value that increases or decreases according to an increase or a decrease in power consumption. The estimated value of power consumption is, for example, an average value of power consumption, but may be a value other than the average value of power consumption. For example, the estimated value of power consumption may be a maximum value or a median value of power consumption. The estimated value of power consumption may be power consumption selected from all pieces of data on the power consumption of the electric vehicle 2, such as an average value or a median value of the power consumption of the top few percent, or may be a value calculated by an arithmetic expression using these values.

The charging management device 5 compares the estimated value which is acquired, and preferentially distributes renewable energy from the electric vehicle 2 with the larger estimated value. In this embodiment, the estimated value of power consumption is an average value of power consumption. The charging management device 5 includes, for example, a charging station management part 51, a management device communication part 52, a storage 53, and a vehicle management part 54. The storage 53 includes, for example, a power consumption database (hereinafter, referred to as DB) 55.

The charging station management part 51 manages the amount of energy of the charging station 3. The charging station management part 51 transmits a charging instruction generated by the vehicle management part 54 to the charging station ECU 34 via the management device communication part 52. The charging station management part 51 transmits the charging instruction generated by the vehicle management part 54 to the charging station 3, and causes the charging station 3 to perform charging of the electric vehicle 2.

The management device communication part 52 includes a communication interface such as a network interface card (NIC card). The management device communication part 52 performs communication with the electric vehicle 2 and the charging station 3 via the network NW to transmit and receive information. The management device communication part 52 receives, for example, the traveling distance and the remaining energy amount SOC that are transmitted by the electric vehicle 2, and transmits the traveling distance and the remaining energy amount to the vehicle management part 54.

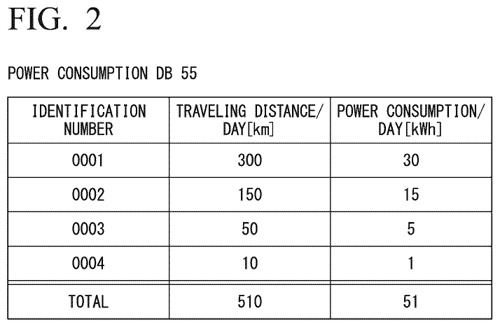

The storage 53 is a semiconductor memory element such as a flash memory, a hard disk, an optical disk, or the like. The storage 53 stores, for example, a power consumption DB 55 related to the average power consumption per day of the plurality of electric vehicles 2. Here, the power consumption DB 55 will be described. FIG. 2 is a diagram illustrating an example of content of the power consumption DB 55.

The power consumption DB 55 includes, for example, information related to the traveling distance and the power consumption per day (daily average) of the plurality of electric vehicles. An identification number is assigned to each of the plurality of electric vehicles 2, and the power consumption DB 55 includes, for each identification number, an average value of each of the traveling distance and the power consumption per day. For example, in a case of the electric vehicle 2 with the identification number of 0001, an average value of the traveling distance per day is 300 km, and an average value of the power consumption per day is 30 kWh.

The vehicle management part 54 includes, for example, a DB update part 56, a power consumption acquisition part 57, and a distribution adjustment part 58. These components are implemented in a case where a hardware processor such as a central processing unit (CPU) executes a program (software). Some or all of these components may be implemented by hardware (a circuit unit; including circuitry) such as a large scale integration (LSI), an application specific integrated circuit (ASIC), a field-programmable gate array (FPGA), or a graphics processing unit (GPU), and may be implemented by software and hardware in cooperation.

The program may be stored in advance in a storage 53 (a storage device including a non-transitory storage medium) such as an HDD or a flash memory. The program may be stored in a removable storage medium (a non-transitory storage medium) such as a DVD or CD-ROM, and may be installed in a case where the storage medium is inserted into a drive device.

The DB update part 56 updates the power consumption DB 55 stored in the storage 53 based on the traveling distance transmitted by the electric vehicle 2. The DB update part 56 updates the power consumption DB 55 by newly calculating an estimated value of the traveling distance per day, for example, an average value of the traveling distance, based on the traveling distance per day that is stored in the power consumption DB, the number of pieces of data used to calculate the traveling distance, and the traveling distance transmitted by the electric vehicle 2.

The DB update part 56 calculates power consumption per day of the electric vehicle 2 based on the traveling distance transmitted by the electric vehicle 2. The DB update part 56 updates the power consumption DB 55 by newly calculating an estimated value of power consumption per day, for example, an average value of power consumption, based on the power consumption per day that is stored in the power consumption DB, the number of pieces of data used to calculate the power consumption, and the calculated power consumption.

In a case where charging of the electric vehicle 2 is performed, the power consumption acquisition part 57 refers to the traveling distance per day that is included in the power consumption DB 55 stored in the storage 53. The power consumption acquisition part 57 calculates power consumption based on the traveling distance which is referred to. The power consumption acquisition part 57 may acquire power consumption by referring to the power consumption per day that is included in the power consumption DB 55. The power consumption acquisition part 57 may acquire power consumption according to an input operation of the input device, or the like.

The distribution adjustment part 58 determines distribution of renewable energy to be used for charging of each of the plurality of electric vehicles 2 based on the power consumption acquired by the power consumption acquisition part 57, the traveling distance, and the remaining energy amount SOC transmitted by the electric vehicle 2. The distribution adjustment part 58 generates a charging instruction including a distribution instruction according to the determined distribution of the amount of renewable energy, and transmits the charging instruction to the charging station ECU 34 via the management device communication part 52.

Subsequently, processing of the charging management device 5 will be described. The charging management device 5 generates a distribution instruction in accordance with a charging cycle for charging the plurality of electric vehicles 2 (in this case, n electric vehicles), and transmits the distribution instruction to the charging station ECU 34. The charging station 3 supplies, to the plurality of electric vehicles 2, power corresponding to the amount of energy based on the distribution instruction transmitted by the charging management device 5, in accordance with the charging cycle.

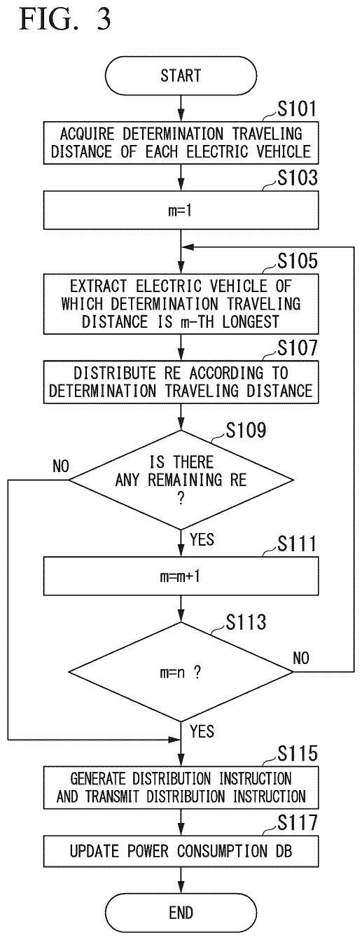

FIG. 3 is a flowchart illustrating an example of processing of the charging management device 5. First, in the charging management device 5, the power consumption acquisition part 57 reads the power consumption DB 55 stored in the storage 53, and acquires, as an estimated value, the traveling distance per day (hereinafter, referred to as “determination traveling distance”) of each of the plurality of electric vehicles 2 that are charging targets (step S101).

Subsequently, the distribution adjustment part 58 sets an order designation counter m, which indicates the order of the electric vehicle (hereinafter, referred to as “target electric vehicle”) for which distribution of power consumption is firstly determined, to 1 (m=1) (step S103). The distribution adjustment part 58 extracts an electric vehicle of which the determination traveling distance is m-th longest (step S105), and determines the electric vehicle as the target electric vehicle. In a case of determining the target vehicle by referring to the power consumption DB 55 illustrated in FIG. 2, the distribution adjustment part 58 extracts an electric vehicle 2 which has an identification number “0001” and of which the determination traveling distance is first longest, and determines the electric vehicle 2 as the target electric vehicle.

Subsequently, the distribution adjustment part 58 distributes the amount of renewable energy (RE) to the target electric vehicle according to the determination traveling distance of the target electric vehicle (step S107). For example, in a case where an electric vehicle 2 which has an identification number “0001” illustrated in FIG. 2 is set as the target electric vehicle, the distribution adjustment part 58 distributes, to the target electric vehicle, the amount of renewable energy that is obtained by subtracting the remaining energy amount SOC of the target electric vehicle from the power consumption per day of the target electric vehicle. In a case where a value obtained by subtracting the remaining energy amount SOC of the target electric vehicle from the power consumption per day is negative (smaller than 0), the amount of energy to be used for charging of the target electric vehicle is zero.

Subsequently, the distribution adjustment part 58 subtracts the amount of renewable energy that is distributed in step S107 from the amount of renewable energy that is transmitted by the charging station ECU 34, and determines whether or not there is any remaining renewable energy that can be used for charging (step S109). In a case where it is determined that there is remaining renewable energy that can be used for charging, the distribution adjustment part 58 increments the order designation counter m (m=m+1) (step S111).

Subsequently, the distribution adjustment part 58 determines whether or not the order designation counter m reaches the number (=n) of the electric vehicles 2 that are charging targets (step S113). In a case where it is determined that the order designation counter m reaches the number (=n) of the electric vehicles 2 that are charging targets, all the power to be used for charging of the electric vehicles 2 can be set as power from renewable energy. In this case, a distribution instruction to distribute all the power from renewable energy as power to be used for charging of the electric vehicles 2 is generated, and the distribution instruction is transmitted to the charging station ECU 34 (step S115).

Subsequently, the DB update part 56 calculates power consumption of each electric vehicle 2 based on the traveling distance of each electric vehicle 2 that is acquired in step S101. The DB update part 56 updates the power consumption DB 55 based on the acquired traveling distance and the calculated power consumption of each electric vehicle 2 (step S117). Thus, the charging management device 5 ends the processing illustrated in FIG. 3.

In a case where it is determined in step S109 that there is no remaining renewable energy that can be used for charging, power from the grid energy is distributed to the electric vehicle for which power from renewable energy is not distributed. The distribution adjustment part 58 generates a distribution instruction according to the distribution of power from grid energy, and transmits the distribution instruction to the charging station ECU 34 (step S115), and updates the power consumption DB 55 (step S117). Thus, the charging management device 5 ends the processing illustrated in FIG. 3. The processing content and the processing procedure are examples and are not limited thereto, and processing according to other processing content and other processing procedures may be performed.

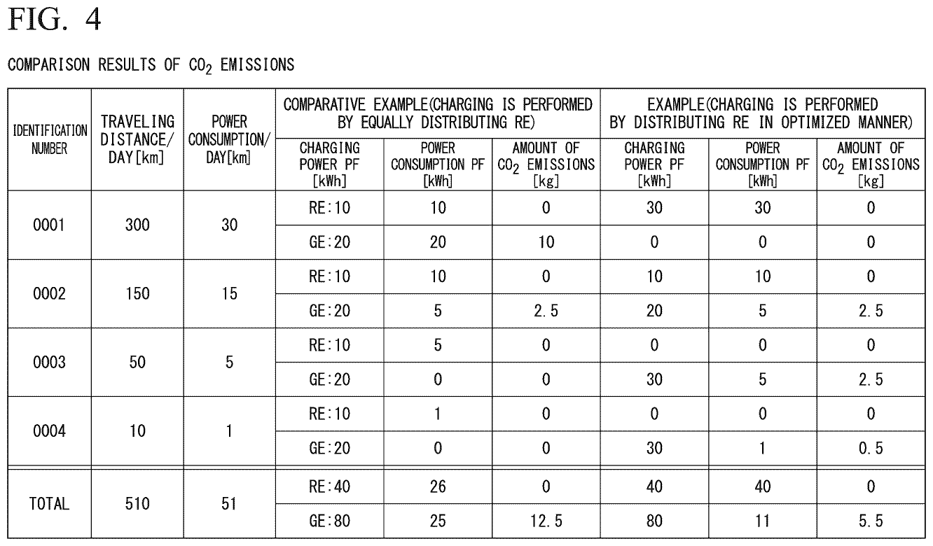

Next, effects of the charging management device 5 according to the embodiment will be described in comparison with a comparative example. FIG. 4 is a diagram illustrating an example of a comparison result of the amounts of CO₂ emissions of a plurality of electric vehicles 2 in the comparative example and the example. In this example, in both the comparative example and the example, it is assumed that each electric vehicle 2 consumes power while traveling during daytime and is charged at night. The amounts of CO₂ emissions were calculated assuming 0 kg per kWh for power consumption from renewable energy and 0.5 kg per kWh for power consumption from grid energy. The electric vehicle 2 travels until the remaining energy amount SOC reaches a minimum value, and is charged until the remaining energy amount SOC reaches a maximum value.

In the comparative example, power from renewable energy was evenly distributed to each electric vehicle 2 for charging. On the other hand, in the example, power from renewable energy was preferentially distributed to an electric vehicle 2 having a longer traveling distance, and power from renewable energy was distributed to each electric vehicle 2 in an optimized manner. As a result, the total amount of CO₂ emissions of the plurality of electric vehicles 2 was 12.5 kg in the comparative example, but was reduced to 5.5 kg in the example.

As described above, the charging management system 1 according to the present embodiment preferentially distributes renewable energy to the electric vehicles having higher estimated values, the electric vehicles being a plurality of electric vehicles 2 that travel using electric energy and are owned by an electric vehicle owner. Thus, the total amount of CO₂ emissions from the plurality of electric vehicles 2 can be reduced, for example, minimized, as compared with a case where renewable energy is equally distributed to each of the electric vehicles 2. Therefore, the total amount of CO₂ emissions when using the plurality of electric vehicles can be reduced.

In the embodiment, the distribution adjustment part 58 distributes renewable energy according to the determination traveling distance of each electric vehicle 2. On the other hand, the distribution adjustment part 58 may distribute renewable energy based on the power consumption per day of each electric vehicle 2 (determination power consumption). In addition, the distribution adjustment part 58 calculates power consumption based on the traveling distance of the electric vehicle 2. On the other hand, the distribution adjustment part 58 may also calculate power consumption based on loads applied to the electric vehicles 2, other than the traveling distance, such as the air conditioning control level of the air conditioning device 26, or by using a combination of these factors.

Further, the program may be transmitted from a computer system that stores the program in a storage device or the like to another computer system via a transmission medium or by transmission waves in a transmission medium. Here, “transmission medium” for transmitting the program refers to a medium that has the function of transmitting information, such as a network (communication network) such as the Internet or a communication line such as a telephone line. In addition, the program may also be used to implement some of the functions. Further, the program may be a so-called differential file (differential program), which can implement the functions in combination with a program already recorded in the computer system.

Although the embodiment of the present invention has been described above, the present invention is not limited to such an embodiment, and various modifications and substitutions can be made within the scope of the gist of the present invention.

What is claimed is:

1. A charging management system comprising:
a charging station to which renewable energy generated by a power generation device and grid energy from a grid energy source are supplied;
a plurality of electric vehicles having an in-vehicle power storage device that charges the renewable energy and the grid energy supplied from the charging station when being electrically connected to the charging station; and
a vehicle management part that manages an amount of the renewable energy stored in the in-vehicle power storage device of each of the plurality of electric vehicles, wherein
the vehicle management part includes a power consumption acquisition part that acquires an estimated value of power consumption per predetermined period of each of the plurality of electric vehicles, and
in a case where charging of each of the plurality of electric vehicles is performed using energy from the charging station, the vehicle management part preferentially charges the renewable energy to an electric vehicle having the greater estimated value.

2. The charging management system according to claim 1, wherein
the predetermined period is a period related to a charging cycle for charging the plurality of electric vehicles.

3. The charging management system according to claim 1, wherein
the estimated value is an average value.

4. The charging management system according to claim 1, wherein
the estimated value relates to at least one of a traveling distance of the electric vehicle or an air conditioning control level of an air conditioning device provided in the electric vehicle.

5. A charging management device comprising:
a vehicle management part that manages an amount of renewable energy stored in an in-vehicle power storage device of each of a plurality of electric vehicles, which have the in-vehicle power storage device that charges the renewable energy and grid energy supplied from a charging station when the in-vehicle power storage device is electrically connected to the charging station, the renewable energy being generated by a power generation device and the grid energy being supplied from a grid energy source, wherein
the vehicle management part includes a power consumption acquisition part that acquires an estimated value of power consumption per predetermined period of each of the plurality of electric vehicles, and
in a case where charging of each of the plurality of electric vehicles is performed using energy from the charging station, the vehicle management part preferentially charges the renewable energy to an electric vehicle having the greater estimated value.

6. A charging management method causing a computer to execute a process comprising:
managing an amount of renewable energy stored in an in-vehicle power storage device of each of a plurality of electric vehicles, which have the in-vehicle power storage device that charges the renewable energy and grid energy supplied from a charging station when the in-vehicle power storage device is electrically connected to the charging station, the renewable energy being generated by a power generation device and the grid energy being supplied from a grid energy source, wherein
the method causes the computer to acquire an estimated value of power consumption per predetermined period of each of the plurality of electric vehicles, and
in a case where charging of each of the plurality of electric vehicles is performed using energy from the charging station, the method causes the computer to preferentially charge the renewable energy to an electric vehicle having the greater estimated value.
